(19) United States
(12) Patent Application Publication
(10) Pub. No.: US 2009/0323773 A1
(43) Pub. Date: Dec. 31, 2009

(54) METHOD AND APPARATUS FOR SIGNALING PRECODING VECTORS

(75) Inventors: Erdem Bala, Farmingdale, NY (US); Sung-Hyuk Shin, Northvale, NJ (US); Philip J. Pietraski, Huntington Station, NY (US); Kyle Jung-lin Pan, Smithtown, NY (US); Donald Grieco, Manhasset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/493,489

(22) Filed: Jun. 29, 2009

Related U.S. Application Data
(60) Provisional application No. 61/077,027, filed on Jun. 30, 2008.

(51) Int. Cl. H04B 1/707; H04B 1/38

(52) U.S. Cl. 375/141; 375/219; 375/260; 375/E01.002

(57) ABSTRACT

Methods for signaling precoding matrices used at the Node-B for data transmission with multiple user-multiple in multiple out (MU-MIMO) wireless communications. Precoding vectors may be efficiently signaled between wireless transmit/receive units and base stations using control channels, reference signals and blind detection of the precoding information.

### CROSS REFERENCE TO RELATED APPLICATIONS

This application claims the benefit of U.S. provisional application No. 61/077,027, filed Jun. 30, 2008, which is incorporated by reference as if fully set forth.

### FIELD OF INVENTION

This application is related to wireless communications.

### BACKGROUND

In the downlink of a multi-user multiple-input-multiple-output (MU-MIMO) wireless communications where the base station (BS) has Nₜ transmit antennas and each wireless transmit/receive unit (WTRU) is equipped with a single or Nᵣ multiple antennas, the multiplexing gain can be achieved by transmitting to multiple users simultaneously. This gain might be achieved by complex coding schemes, such as dirty paper coding, which are difficult to implement in practice.

A method that has little complexity and can be effectively implemented is beamforming. In beamforming, the data stream of each user is multiplied by a beamforming vector. Then, the resulting streams are summed and transmitted from the transmitter antennas. In the more general case when multiple data streams are transmitted to each user, the beamforming vector for the user becomes a matrix and each data stream of the user is multiplied with a column vector of the matrix.

The beamforming vectors may be designed to meet optimality criteria. If these vectors are selected by taking the spatial signatures of the users into consideration, the interference among different streams may be reduced. One specific method to design the beamforming vectors is called the zero-forcing beamforming. The beamforming vectors are selected such that the interference among different data streams becomes zero.

To compute the beamforming vectors, the BS requires the channel state information of all the WTRUs. The WTRUs estimate their channels, normalize the channels, and quantize the normalized channels by using a channel quantization codebook. Then, the index of a selected quantization vector of the codebook is signaled to the transmitter with a channel quality indicator (CQI). Quantization is an exemplary technique and other data reduction techniques may be used.

After the BS receives the information from the WTRUs, the BS performs a WTRU selection process and then computes the beamforming vectors for the selected WTRUs. These beamforming vectors are used to precode the data stream for each WTRU. The BS signals each WTRU about which beamforming vector is being used for its transmission so that the WTRUs can design the appropriate receive filters.

Another approach that can be used for MU-MIMO is for the WTRU to select the precoding vector from a codebook and signal the selected vector to the BS. Unitary precoding is an example of this kind of technique. In unitary precoding, the precoding codebook consists of unitary matrices where each column in a matrix is a candidate precoding vector. A WTRU selects the best precoding vector from one of the matrices and signals the index of the selected vector to the BS. WTRUs that select different precoding vectors from the same unitary matrix are paired and a precoding vector is used for transmission to the WTRU which had selected that precoding vector.

Efficient methods for signaling the precoding vectors between the BS and the WTRU(s) are needed.

### SUMMARY

A method and apparatus for signaling precoding vectors between a base station and wireless transmit/receive units (WTRU) are disclosed. Zero-forcing beamforming (ZF) and unitary precoding are procedures that have been proposed for data transmission in the downlink of multiuser multi-input multi-output (MU-MIMO) wireless communications. Methods for signaling the precoding matrices used at the base station for data transmission with MU-MIMO are disclosed.

In general, the downlink control signaling may be explicit signaling using control channel, e.g., physical downlink control channel (PDCCH). Alternatively the downlink signaling may be performed via implicit signaling using dedicated reference signals (RS) and blind detection of the beamforming information by using the RSs at the WTRU.

Even though the methods discussed herein relate to ZF MU-MIMO and unitary precoding, the proposed signaling methods may be applied to any type of MU-MIMO (and/or multi-cell MIMO) wireless communications.

### BRIEF DESCRIPTION OF THE DRAWINGS

A more detailed understanding may be had from the following description, given by way of example in conjunction with the accompanying drawings wherein:

FIG. 1 shows a wireless communication system/access network of Long Term Evolution (LTE);

FIG. 2 is a functional block diagram of a wireless transmit/receive unit (WTRU), the base station and the Mobility Management Entity/Serving Gateway (MME/S-GW) of the wireless communication system of FIG. 2;

FIG. 3 is a flowchart of one embodiment to signal precoding vectors;

FIG. 4 is a flowchart of another embodiment to signal precoding vectors; and

FIG. 5 is a flowchart of another embodiment to signal precoding vectors.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a BS, an evolved Node B (eNB), a site controller, an access point (AP), or any other type of interfacing device capable of operating in a wireless environment.

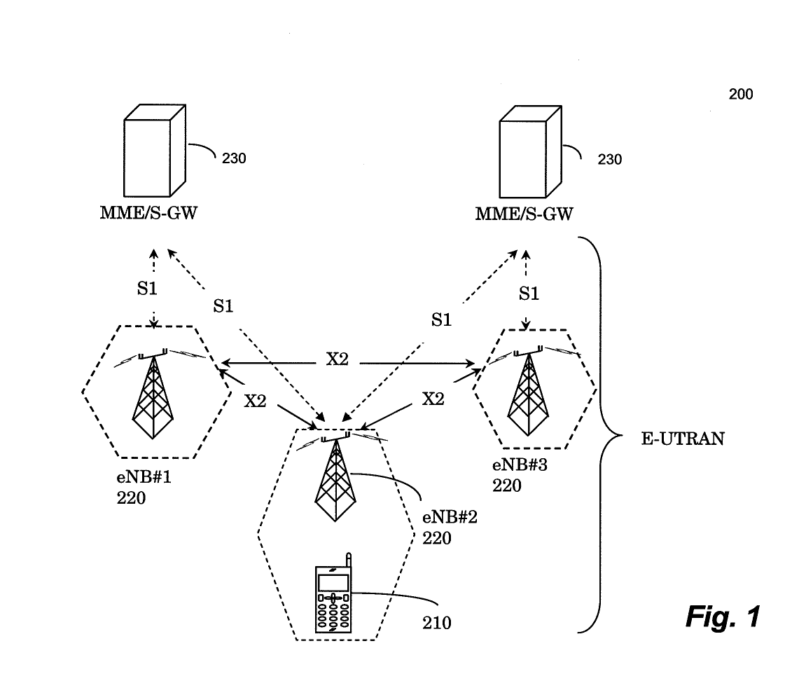

FIG. 1 shows a wireless communication system/access network of Long Term Evolution (LTE) 200, which includes an Evolved-Universal Terrestrial Radio Access Network (E-UTRAN). The E-UTRAN as shown, includes a WTRU 210 and a base station, for example, such as several evolved Node Bs (eNBs) 220. As shown in FIG. 1, the WTRU 210 is in communication with an eNB 220. The eNBs 220 interface with each other using an X2 interface. The eNBs 220 are also connected to a Mobility Management Entity (MME)/Serving GateWay (S-GW) 230, through an S1 interface. Although a single WTRU 210 and three eNBs 220 are shown in FIG. 1, it should be apparent that any combination of wireless and wired devices may be included in the wireless communication system 200.

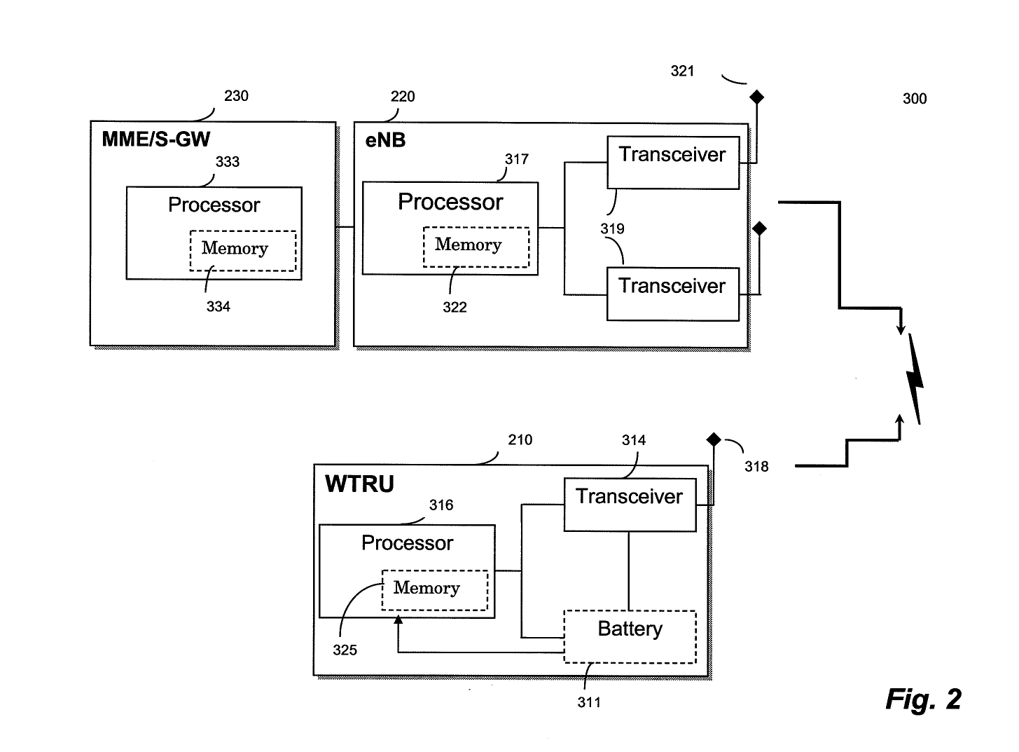

FIG. 2 is an example block diagram 300 of the WTRU 210, the eNB 220, and the MME/S-GW 230 of the wireless communication system 200 of FIG. 1. As shown in FIG. 2, the WTRU 210, the eNB 220 and the MME/S-GW 230 are configured to perform a method for signaling precoding vectors between a base station and wireless transmit/receive units (WTRU) in multi-user multiple-in-multiple-out (MU-MIMO) wireless communications.

In addition to the components that may be found in a typical WTRU, the WTRU 210 includes a processor 316 with an optional linked memory 325, a transmitter and receiver together designated as transceiver 314, an optional battery 311, and an antenna 318 (the antenna may be two or more units). The processor 316 is configured to perform a method for signaling precoding vectors between a base station and wireless transmit/receive units (WTRU) in multi-user multiple-input multiple-output (MU-MIMO) wireless communications. The transceiver 314 is in communication with the processor 316 to facilitate the transmission and reception of wireless communications. In case a battery 311 is used in WTRU 210, it powers both the transceiver 314 and the processor 316.

In addition to the components that may be found in a typical eNB, the eNB 220 includes a processor 317 with an optional linked memory 322, transceivers 319, and antennas 321. The processor 317 is configured to perform a method for signaling precoding vectors between a base station and wireless transmit/receive units (WTRU) in multi-user multiple-input multiple-output (MU-MIMO) wireless communications. The transceivers 319 are in communication with the processor 317 and antennas 321 to facilitate the transmission and reception of wireless communications. The eNB 220 is connected to the Mobility Management Entity/Serving-GateWay (MME/S-GW) 230 which includes a processor 333 with an optional linked memory 334.

As discussed herein, when zero-forcing (ZF) beamforming is used for MU-MIMO transmission, the precoding vectors may be signaled to the scheduled WTRUs so that the effective channels may be computed and used to design the receive filter. This is also true for unitary precoding. Accordingly, several efficient methods for downlink control signaling of the precoding vectors are disclosed herein.

An example of a ZF beamforming procedure follows. Assume that the BS has a number M transmit antennas and there are a number L active users (WTRUs), out of which a number K WTRUs would be scheduled for simultaneous transmission. Additionally, assume that the BS transmits a single data stream to each WTRU and that each WTRU has a single receive antenna. Note that these assumptions are for illustration purposes only and could be generalized to multiple data streams for each WTRU and multiple receive antennas for each WTRU. In the more general case of multiple receive antennas at a WTRU, there would be a combining vector at the receiver.

Let sₖ be the data symbol that is transmitted to the k^{th} WTRU, and Pₖ be the power allocated for this WTRU. The data symbol for each WTRU is multiplied with a beamforming vector wₖ. Then, the transmitted signal from the BS is given as

$${\sum }_{k = 1}^{K} {P}_{k} {w}_{k} {s}_{k} .$$

For WTRU k, the received signal yₖ is given by

$${y}_{k} = \sqrt{{P}_{k}} {h}_{k} {w}_{k} {s}_{k} + {\sum }_{j = 1 , j \neq k}^{K} \sqrt{{P}_{j}} {h}_{k} {w}_{j} {s}_{j} + {n}_{k}$$

where hₖ denotes the channel from the BS to the WTRU k. The first part of the received signal is the data stream transmitted to WTRU k; the second part is data transmitted to the other WTRUs, i.e. inter-user or inter-stream interference, and the third part is the noise. In ZF beamforming, the beamforming vectors are chosen such that hₖwⱼ=0, for k≠j. This condition guarantees that the inter-user interference is completely cancelled.

One way of accomplishing the zero inter-user interference condition is to compute the beamforming vectors from the pseudo-inverse of the composite channel matrix as follows: The composite channel matrix may be defined as H=[h₁ h₂ . . . h_{K}] and the composite beamforming matrix as W=[w₁ w₂ . . . w_{K}]. Then, the zero inter-user interference condition may be satisfied if W=H^{†}=H^{H}(HH^{H})⁻¹. If the correlation between the channels of the paired WTRUs is large, the channel matrix H is poorly conditioned and the effective channel gains are reduced. So, WTRUs with less correlated channels may be paired for ZF beamforming.

To achieve the optimal performance of the zero-forcing beamforming approach, the BS requires the perfect channel state information of all WTRUs. This is performed by the WTRU estimating the channel and feeding the information back to the BS. Due to the practical limits on channel estimation and the capacity of the feedback channel, the precise channel state cannot be known by the BS. Instead, the estimated channel is quantized according to a given codebook and then the index from the codebook is transmitted to the BS.

Assume that the codebook used for channel quantization, called the WTRU codebook, consists of N unit-norm vectors, and is denoted as C_{WTRU}={c₁, c₂, . . . , c_{N}}. Each WTRU first normalizes its channel h and then selects the closest codebook vector that can represent the channel. The normalization process loses the amplitude information and only the direction/spatial signature of the channel is retained. Quantization may be performed according to the minimum Euclidian distance such that ĥₖ=cₙ,

$$n = arg {max}_{i = 1 , … , N} \vert {\tilde{h}}_{k} {c}_{i}^{H} \vert$$

where \tilde{h}ₖ denotes the normalized channel and ĥₖ is the quantized channel. The WTRU feeds back the index n to the BS. In addition to the channel direction, the UE also feeds back a channel quality indicator (CQI) value which could be a representation of the SINR. So, the CQI contains information about the channel magnitude and the power of interference and noise.

Due to the channel quantization error, the condition hₖwⱼ=0, k≠j is not satisfied any more because the beamforming matrix W is computed by using the quantized channel vectors ĥₖ but not hₖ. Given that the received signal at user k is

$${y}_{k} = \sqrt{{P}_{k}} {h}_{k} {w}_{k} {s}_{k} + {\sum }_{j = 1 , j \neq k}^{K} \sqrt{{P}_{j}} {h}_{k} {w}_{j} {s}_{j} + {n}_{k} ,$$

the SINR becomes

$${SINR}_{k} = \frac{{p}_{k} {\vert {h}_{k} {w}_{k}^{*} \vert}^{2}}{{σ}^{2} + {\sum }_{i \neq k} {p}_{i} {\vert {h}_{k} {w}_{i}^{*} \vert}^{2}}$$

where σ² denotes the noise variance and possibly the inter-cell interference.

Implementation of zero-forcing beamforming may cancel the inter-user interference completely. For example, if two WTRUs denoted by “1” and “2” are paired, the signal received by WTRU 1 is y₁=√P₁h₁w₁s₁+√P₂h₁w₂s₂+n₁. Ideally, h₁w₂=0 but this is not true in general due to the channel quantization error. The inter-stream interference √P₂h₁w₂s₂ can be cancelled (though probably not completely) by WTRU 1 of it has some knowledge about w₂. One method for WTRU 1 to learn w₂ is to have the BS signal this information in the control channel. If the interfering WTRU's precoding vector, i.e., w₂, is not transmitted, then the BS signals only the beamforming vector that is desired for the target WTRU, i.e., w₁.

If the beamforming vectors are distinct for a set of given composite channel matrices, i.e., every H=[ĥ₁ ĥ₂ . . . ĥ_{K}] results in a different W=[w₁ w₂ . . . w_{K}], then knowledge of the WTRUs own precoding vector would imply knowledge of the interfering vectors as well.

In one embodiment, assume that two WTRUs are being paired for MU-MIMO transmission and the channel quantization vectors for WTRU 1 and WTRU 2 are ĥ₁ are ĥ₂, respectively. If the channel quantization codebook size is given by N, then there are N possible values for each vector and each may be represented by ceil(log2(N)) bits.

Consider the signaling for WTRU 1. Given that the quantized channel of this WTRU is ĥ₁, the other paired WTRU's channel may also be one of the N possibilities. The number of possibilities may be reduced by allowing only selected pairings, for example, channel vectors whose correlations are below a threshold may be paired only. By using such a restriction, assume that the other paired WTRU's quantized channel take M values where M<N.

The composite channel matrix may be defined as H=[ĥ₁ĥ₂], and therefore the beamforming matrix W=H^{†}=H^{H}(HH^{H})⁻¹=[w₁ W₂] may then be represented with log₂(M) bits. Because the channel quantization codebook is known, the beamforming matrix codebook is also known in advance. So w₁ may be signaled with log₂(M) bits. If each beamforming matrix W is distinct, then knowledge of w₁ would also imply knowledge of w₂. Therefore, with log₂(M) bits, the precoding vectors of both the target WTRU and the interfering WTRU may be transmitted by signaling an index for the selected W.

Equivalently, log₂(M) bits also indicate a specific W. In general, it may also be necessary to indicate which column (or row) of W is the target WTRU's beamforming vector. This, however, may be achieved without additional signaling by using ordered vectors to form the channel matrix H. As an example, if the channel quantization vectors are placed in channel matrix H from left to right with increasing indices, then the WTRU may determine the correct beamforming vector.

As an example of the above identified method, assume that channel quantization vector can be one of three vectors and it is not allowed to pair two WTRUs whose channels can represented with the same channel quantization vector. WTRU 1 has channel ĥ₂ and the paired WTRU has channel ĥ₃. Then H_{2,3}=[ĥ₂ĥ₃]→W_{2,3}=[w₂ w₃]. If the paired WTRU has channel ĥ₁, then H_{1,2}=[ĥ₁ĥ₂]→W_{1,2}=[w₁ w₂]. We can use a single bit to indicate either W_{2,3} or W_{1,2} as the beamforming matrix. IF WTRU 1 gets the index for W_{2,3} in the control channel, it can decide that the composite channel matrix was H_{2,3} and its own beamforming vector is in the first column of the beamforming matrix and the other column is as the beamforming vector for the paired WTRU. So, given the target WTRU's channel, all possible composite channel matrices and therefore beamforming matrices may be determined from a table.

If the ZF beamforming method is used in a frequency selective manner, then the beamforming vector, which may be different for each frequency block, may be transmitted for each frequency block. If there is wideband beamforming, then the same single beamforming vector maybe used for the whole band.

In another embodiment, the quantized channel of the paired WTRU may be signaled. For example, if the BS signals the index of ĥ₂ to WTRU 1, then WTRU 1 may compute both of the precoding vectors as it already knows its own quantized channel. This also requires log₂(M) bits for signaling.

In the embodiments discussed herein, it has been assumed that the BS uses the channel information from the WTRUs. This would be true in general because the BS cannot change the reported channel information. This, however, requires that the channel information reported is accurate. The reporting accuracy may be increased by increasing the coding strength of the feedback channel and reducing the feedback error to a minimum.

In another embodiment, the method discussed herein maybe performed when more than two WTRUs are paired for MU-MIMO transmission. In this case, however, the signaling overhead may increase due to the larger number of possibilities. For example, a number log₂(K) bits may be needed to transmit the precoding vectors if channel matrix H=[ĥ₁ ĥ₂ ĥ₃] is one of K values after excluding channel vectors whose correlations are above a certain threshold.

The signaling overhead maybe reduced further by limiting the number of WTRUs, applying more restrictions on WTRU pairings or reducing the size of the precoding matrix codebook by quantization.

Similarly, the indices of the quantized channel vectors of the paired WTRUs may also be transmitted. For example, the indices of ĥ₂ and ĥ₃ may be transmitted to WTRU 1. The signaling overhead may be reduced by imposing the same kind of pairing restrictions as described above. If M channel pairings are allowed, then m*log₂(M) bits may be used to signal the channels of the m interfering WTRUs.

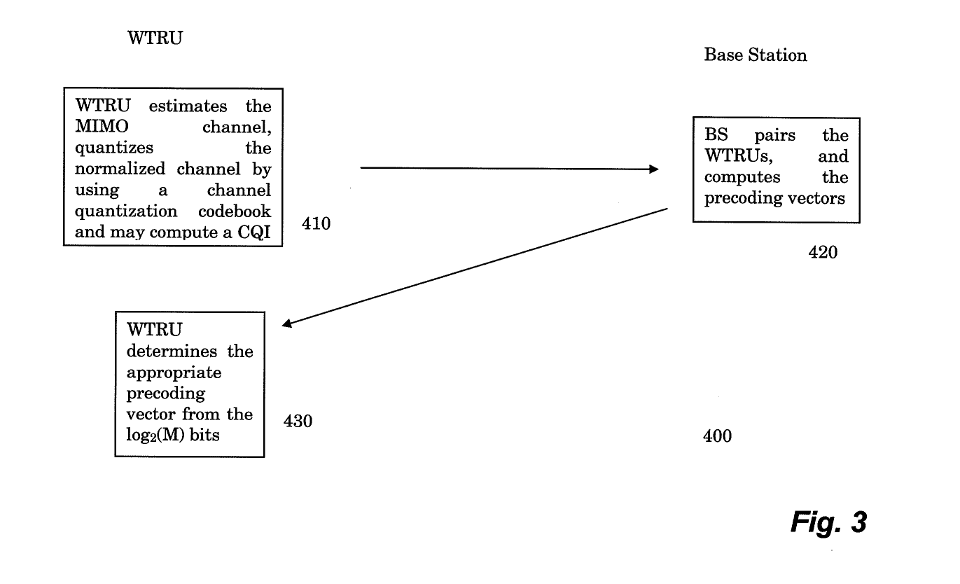

Referring now to FIG. 3, there is shown an embodiment for a method for reducing signaling overhead when more than two WTRUs are paired for MU-MIMO transmission (400). First, the WTRU estimates the MIMO channel and quantizes the normalized channel by using a channel quantization codebook (410). The WTRU also computes a CQI. The selected index from the channel quantization codebook and the CQI are transmitted to the BS either in the uplink shared channel or the uplink control channel. Channel quantization and CQI computation may be performed for the whole band or separately per a group of subcarriers.

The BS scheduler pairs the WTRUs, computes the beamforming matrices by using the channel vectors of the paired WTRUs and the modulation coding scheme (MCS) per scheduled WTRU (420). The WTRU is informed of the parameters required to receive the transmission via the downlink control channel and/or dedicated reference signals. By using the configuration information, the WTRU receives the information about the beamforming vectors by log₂(M) bits/states in the control channel where M denotes the number of possible beamforming matrices, or equivalently the possible channel matrices (430). By using the one-to-one mapping between channel matrices and beamforming matrices, i.e., H_{i,j}→W_{i,j}, the WTRU detects which column of W is associated with its own precoding vector, the rest of the columns belong to the interfering WTRUs.

Alternatively, the log₂(M) bits/state/index may indicate the ordered channel matrix that consists of the channels of the paired WTRUs. By using this channel matrix and its own channel, the WTRU may then compute W.

The possible ordered channel matrices and/or beamforming matrices are stored in the WTRU and the BS. The bit/state/index transmitted in the control channel indicates the corresponding entity. Finally, a one bit/state sequence may be transmitted for the whole transmission bandwidth or per a group of subcarriers. The WTRU may also receive, via the control channel, a transmission indicating the number of WTRUs paired by the BS. The WTRU uses the number to determine the correct channel matrix H or W from the table. Alternatively, this number may be configured semi-statistically.

In another embodiment, in addition to using the control channel, dedicated reference signals (RSs) may be used to indicate the precoding vectors that will be used. Assume that the beamforming vector is given by Wk. The BS precodes the pilot symbols, denoted by p, as (y=wₖp) and transmits each element of the vector y from one of the antennas on selected subcarriers. Then the WTRU estimates the precoding vector from the received signal. The precoded pilots may be transmitted over several subcarriers for improved detection performance.

As discussed herein, if the beamforming vectors are distinct for given composite channel matrices, then a WTRU's knowledge of its own precoding vector implies knowledge of the interfering vectors as well.

The dedicated RSs are transmitted on the Radio Bearers (RBs) allocated for data transmission. Different RSs for different paired WTRUs may be multiplexed. The multiplexing may be performed in the frequency domain, using reserved subcarriers that are known to the WTRUs. In another variation of this method, the dedicated RSs can be multiplexed by using different spreading sequences. A WTRU may require the indices of the reserved subcarriers that carry the dedicated RSs for itself and/or the indices of the spreading sequence(s). The indices may be transmitted; however this will result in increased signaling overhead. Alternately, implicit mapping may be used. In implicit mapping, the indices may be mapped to a predetermined parameter that is distinct for each paired WTRU. If the WTRU can determine the location of the dedicated RSs for the paired WTRUs, it may also detect the interfering precoding vectors. In addition to the precoding vectors, dedicated RSs may be used to transmit the quantized channel vectors of the interfering WTRUs. The RSs may be defined as (y=ĥₚ), where ĥ is the quantized channel vector of the interfering WTRU. When there is more than one interfering WTRU, separate dedicated RSs may be used to signal each interfering WTRU's channel or a single dedicated RS may be used to transmit, for example, a linear combination of the channel vectors. If the used linear combination is distinct, then the WTRU may receive all interfering channel vectors from the RS. For example, if there are two interfering WTRUs, then WTRU 1 may decode the required information from y=(ĥ₂+ĥ₃)p. A dedicated RS that is common to all paired WTRUs may also be transmitted in order to reduce the signaling overhead. For example, if y=(ĥ₁+ĥ₂+ĥ₃)p is transmitted, every WTRU may subtract its own quantized channel vector from RS y and then detect the interfering WTRUs. For example, WTRU 1 may subtract ĥ₁p from RS y and the use the remaining y=(ĥ₂+ĥ₃)p.

The same techniques may be used to reduce the signaling overhead of dedicated RSs when the RSs are multiplied with the beamforming weights. As an example, instead of transmitting w separately to each WTRU, y=(w₁+w₂+w₃)p may be transmitted. Due to the zero-forcing condition, the amplitude of hᵢwⱼ is small, so the i'th WTRU may decode its own precoding vector. The interfering precoding vectors may also be detected from this received signal.

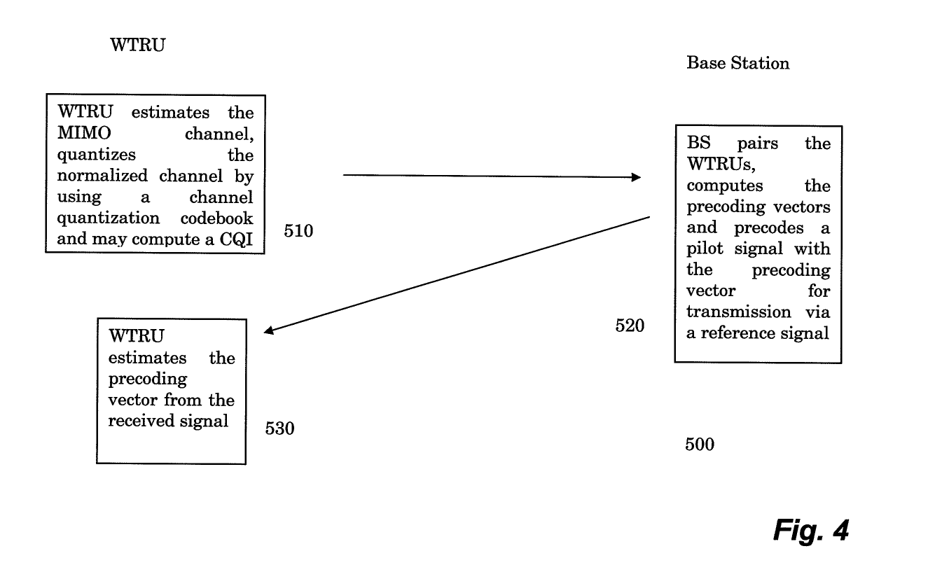

Referring now to FIG. 4, there is shown an example method to indicate the precoding vectors using dedicated RSs (500). The WTRU estimates the MIMO channel and quantizes the normalized channel by using a channel quantization codebook (510). The WTRU also computes a CQI. The index selected from the channel quantization codebook and the CQI are transmitted to the BS either in the uplink shared channel or the uplink control channel. Channel quantization and CQI computation may be performed for the whole band or separately per a group of subcarriers.

The BS scheduler pairs the WTRUs, computes the beamforming matrices by using the channel vectors of the paired WTRUs and the MCS per scheduled WTRU (520). The WTRU is informed of the parameters required to receive the transmission via the downlink control channel and/or dedicated reference signals.

The WTRU may receive the information about the beamforming vectors from dedicated RSs that are transmitted in the frequency range where the WTRU is scheduled for data transmission (530). The dedicated RS represents the WTRU's own beamforming vector. Another RS may be precoded with the interfering beamforming vectors or the same RS may be precoded with a linear combination of all of the beamforming vectors. The dedicated RS may also be precoded with a linear combination of all of the channel vectors. The information RSs carry (beamforming vectors or channel vectors) may either be signaled or preconfigured.

If only the WTRU's own beamforming vector is transmitted with the dedicated RS, then the WTRU does not need to know the number of interfering WTRUs.

In another embodiment, ZF beamforming may be used in a frequency selective manner or non-frequency selective manner. If frequency-selective ZF beamforming is used, a different beamforming matrix is computed per each Radio Bearer Group (RBG). Because the number of RBGs allocated to a WTRU may change from subframe to subframe, signaling the precoding vectors (or the quantized channel vectors) per RBG in the control channel may result in a change of the size of the control channel. In this case, the control channel may be configured to support the maximum number of schedulable RBGs. Alternatively, dedicated RSs may also be used. Whether dedicated RSs are used for frequency-selective operation may be configured or may be signaled dynamically.

With wideband ZF beamforming, only one precoding vector is used for all of the allocated RBGs. In this case, the precoding vector (or the quantized channel vector) may either be signaled in the control channel or with dedicated RSs. Wideband beamforming may be used when closely spaced antennas are used to create correlated channels.

In another embodiment, unitary precoding may be used. Unitary precoding is different from ZF beamforming because the WTRU reports the index of a preferred precoding vector. Therefore, in this embodiment the BS may not transmit the used precoding vector back to the WTRU unless another precoding vector is used. The BS may, instead, transmit a confirmation with a single bit or a state. Accordingly, when frequency-selective precoding is used, the precoding vectors for all of the allocated RBGs may be confirmed. Additionally, dedicated RSs may be used to transmit the precoding vector. When dedicated RSs are used, the BS may override the WTRU decision and use another precoding vector for an arbitrary RBG. When a control channel is used, on the other hand, overriding the WTRU selection for an arbitrary RBG would require increasing the control channel size. To prevent the increase in the control channel size, the BS may use the same precoding vector for all of the scheduled RBGs on the condition that the BS decides to override the WTRU.

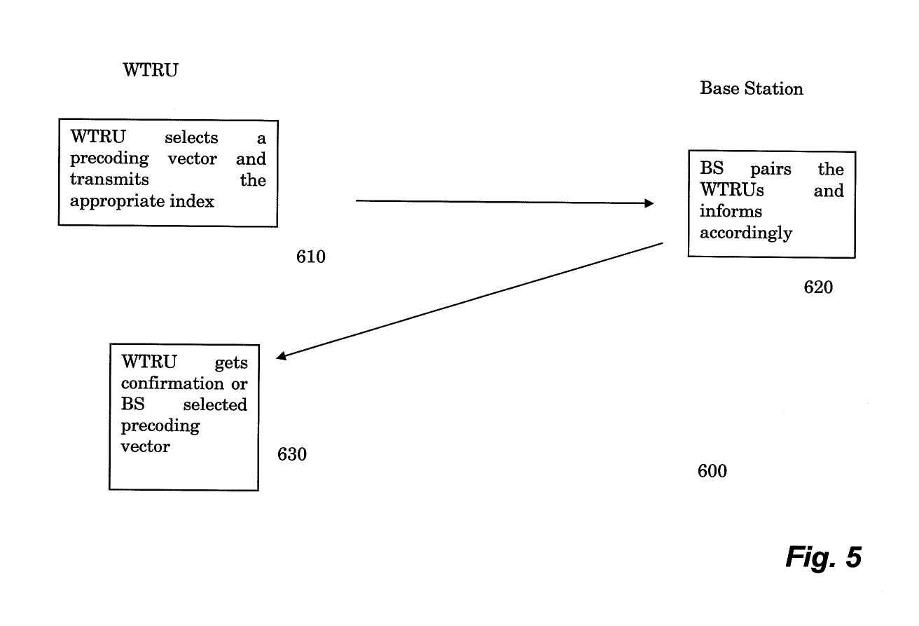

Referring now to FIG. 5, there is shown an example method for signaling using unitary precoding (500). The unitary codebook comprises unitary matrices and each matrix includes potential precoding vectors. The WTRU selects the best precoding vector in a unitary matrix from the codebook and transmits the index of this vector to the BS with a CQI (510). This data may be transmitted either in the uplink control channel or the uplink share channel. A separate index may be transmitted for a group of subcarriers or alternatively, a single index may be transmitted.

The BS pairs the WTRUs and informs the WTRUs of the precoding vectors selected for transmission (520). The WTRU may receive a bit sequence/state which means that its own selection of precoding vectors is confirmed (530). The WTRU may also receive a bit sequence/state which means that its own selection of the precoding vectors is not confirmed. In this case, the WTRU also receives information regarding which precoding vectors are used. There may be one precoding vector for the whole transmission band or separate vectors for groups of subcarriers. The WTRU may also receive dedicated RSs that are multiplied with the precoding vector over the groups of subcarriers scheduled for transmission. If every group of subcarriers uses a different precoding vector, then the RSs in those groups are multiplied with the corresponding vector.

In another embodiment, the WTRUs that are paired in zero-forcing beamforming, may need to learn the same W or H matrices. As described above, the W or H matrix information may be transmitted to every WTRU in its respective control channel. The control channel overhead may be reduced by using a common control area which may be accessed by a group of paired WTRUs. The common control area may contain the common information as W or H matrices, resource allocation, MCS, etc.

In an alternate embodiment the WTRU may blindly detect its own precoding vectors if no information is transmitted via the control channel or with dedicated RSs about the precoding vectors. The complexity of blind detection may be reduced, if the same precoding vector is used for the whole transmission band and the number of possible precoding vectors is limited. The WTRU may perform blind detection by using all possible precoding vectors to decode the received data and finally selecting the precoding vector with which decoding has been successful.

In general, disclosed is a method to signal a precoding matrix. The method includes transmitting an estimate of channel state information, receiving a selected precoding matrix based on at least one channel state information estimate, and receiving a number indicative of paired wireless transmit/receive units (WTRUs), where the precoding matrices are distinct and knowledge of a WTRU's own precoding vector implies knowledge of any interfering precoding vectors. The precoding matrix selection reducing the number of possibilities by allowing only predefined WTRU pairings. The WTRUs having channel estimate vectors whose correlations are below a predefined threshold can be paired. The method including receiving an index related to the selected precoding matrix for target paired WTRUs. The method including receiving an indication of which column (or row) of the selected precoding matrix is a target WTRU's beamforming vector, where a different precoding matrix is signaled for each frequency block in a frequency selective mode. The method including receiving a quantized channel for a non-target WTRU of the paired WTRUs and computing the selected precoding vectors for all WTRUs in the paired WTRUs, where the precoding matrix codebook size is reduced by quantization. The method further including detecting which column or row of the selected precoding matrix is a target WTRU's own precoding vector and determining that a remaining precoding vectors of the selected precoding matrix belong to interfering WTRUs. A channel matrix comprised of channel state information estimates is set in a predetermined order. The method including using an ordered channel matrix and a WTRU's own channel state information estimate to compute the selected precoding vector, wherein a common control area is used that can be accessed by a group of paired WTRUs.

In general, disclosed is a method to signal a precoding matrix, the method including transmitting an estimate of channel state information, receiving a reference signal (RS) having at least one precoded precoding vector that is based on at least one channel state information estimate and estimating at least one precoding vector from a received reference signal. The method having at least one RS transmitted to identify precoding vectors. The method including precoding pilot symbols with at least one precoding vector, and transmitting each element of a vector from an antenna on selected subcarriers. The method where different RSs for different paired WTRUs are multiplexed. The method including receiving indices of reserved subcarriers that carry RSs. The method including receiving indices of at least one spreading sequence used to spread the RSs. The method including receiving indices indicating which multiplexed RSs corresponds to a particular WTRU. The method including receiving indices indicating which multiplexed RSs corresponds to paired WTRUs, where indices of the subcarriers are mapped to a parameter that is distinct for each paired WTRU. The method where indices indicating which multiplexed RSs corresponds to a particular WTRU are mapped to a parameter that is distinct for each paired WTRU. The method where indices indicating which multiplexed RSs corresponds to particular WTRUs are configured. The method where indices of spreading sequences are mapped to a parameter that is distinct for each paired WTRU. The method including receiving a RS that is common to all paired WTRUs. The method including precoding an RS with a linear combination of all precoding vectors. The method where dedicated RSs are used to signal the quantized channel vectors of the interfering WTRUs.

In general, disclosed is a method to signal a precoding matrix, the method including transmitting an estimate of channel state information, receiving a reference signal (RS) having a non-target WTRU precoded channel vector that is based on at least one channel state information estimate, and computing at least one precoding vector from a received reference signal.

In general, disclosed is a method to signal a precoding matrix, the method including selecting a precoding vector from a unitary matrix from a unitary codebook, transmitting an index of this unitary vector with a CQI, and receiving a confirmation message based on other precoding vectors and wireless transmit/receive pairings and on condition that the confirmation message is negative, further receiving another precoding vector, where the unitary codebook comprises unitary matrices and each matrix includes potential precoding vectors. The method where the same another precoding vector is used for all resource block groups. The method where the another precoding vector is received over a receiving a reference signal (RS) having at least one precoded precoding vector.

In general, disclosed is a wireless transmit/receive unit (WTRU) using precoding matrix signaling, including a transmitter transmitting an estimate of channel state information, a receiver receiving a selected precoding matrix based on at least one channel state information estimate, and the receiver receiving a number of paired wireless transmit/receive units (WTRUs), where precoding matrices are distinct and knowledge of a WTRU's own precoding vector implies knowledge of any interfering precoding vectors.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a software defined radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module or a Near Field Communication (NFC) Module.

What is claimed is:

1. A method to signal a precoding matrix, the method comprising:
transmitting an estimate of channel state information;
receiving a selected precoding matrix based on at least one channel state information estimate; and
receiving a number indicative of paired wireless transmit/receive units (WTRUs),
wherein precoding matrices are distinct and knowledge of a WTRU's own precoding vector implies knowledge of any interfering precoding vectors.

2. The method as in claim 1, wherein precoding matrix selection reduces the number of possibilities by allowing only predefined WTRU pairings.

3. The method as in claim 1, wherein WTRUs having channel estimate vectors whose correlations are below a predefined threshold can be paired.

4. The method as in claim 1, wherein receiving further comprises receiving an index related to the selected precoding matrix for target paired WTRUs.

5. The method as in claim 1, wherein receiving further comprises receiving an indication of which column (or row) of the selected precoding matrix is a target WTRU's beamforming vector.

6. The method as in claim 1, wherein a different precoding matrix is signaled for each frequency block in a frequency selective mode.

7. The method as in claim 1, wherein receiving further comprises:
receiving a quantized channel for a non-target WTRU of the paired WTRUs; and
computing the selected precoding vectors for all WTRUs in the paired WTRUs;

8. The method as in claim 1, wherein a precoding matrix codebook size is reduced by quantization.

9. The method as in claim 1, further comprising:
detecting which column or row of the selected precoding matrix is a target WTRU's own precoding vector; and
determining that a remaining precoding vectors of the selected precoding matrix belong to interfering WTRUs.

10. The method as in claim 1, wherein a channel matrix comprised of channel state information estimates is set in a predetermined order.

11. The method as in claim 10, further comprising:
using an ordered channel matrix and a WTRU's own channel state information estimate to compute the selected precoding vector.

12. The method as in claim 1, wherein a common control area is used that can be accessed by a group of paired WTRUs.

13. A method to signal a precoding matrix, the method comprising:
transmitting an estimate of channel state information;
receiving a reference signal (RS) having at least one precoded precoding vector that is based on at least one channel state information estimate; and
estimating at least one precoding vector from a received reference signal.

14. The method as in claim 13, wherein at least one RS is transmitted to identify precoding vectors.

15. The method as in claim 13, further comprising:
precoding pilot symbols with at least one precoding vector; and
transmitting each element of a vector from an antenna on selected subcarriers.

16. The method as in claim 13, wherein different RSs for different paired WTRUs are multiplexed.

17. The method as in claim 13, further comprising receiving indices of reserved subcarriers that carry RSs.

18. The method as in claim 13, further comprising receiving indices of at least one spreading sequence used to spread the RSs.

19. The method as in claim 13, further comprising receiving indices indicating which multiplexed RSs corresponds to a particular WTRU.

20. The method as in claim 13, further comprising receiving indices indicating which multiplexed RSs corresponds to paired WTRUs.

21. The method as in claim 13, wherein indices of the subcarriers are mapped to a parameter that is distinct for each paired WTRU.

22. The method as in claim 13, wherein indices indicating which multiplexed RSs corresponds to a particular WTRU are mapped to a parameter that is distinct for each paired WTRU.

23. The method as in claim 13, wherein indices indicating which multiplexed RSs corresponds to particular WTRUs are configured.

24. The method as in claim 13, wherein indices of spreading sequences are mapped to a parameter that is distinct for each paired WTRU.

25. The method as in claim 13, further comprising receiving a RS that is common to all paired WTRUs.

26. The method as in claim 13, further comprising:
precoding an RS with a linear combination of all precoding vectors.

27. The method as in claim 13, wherein dedicated RSs are used to signal the quantized channel vectors of the interfering WTRUs.

28. A method to signal a precoding matrix, the method comprising:
transmitting an estimate of channel state information;
receiving a reference signal (RS) having a non-target WTRU precoded channel vector that is based on at least one channel state information estimate; and
computing at least one precoding vector from a received reference signal.

29. A method to signal a precoding matrix, the method comprising:
selecting a precoding vector from a unitary matrix from a unitary codebook;
transmitting an index of this unitary vector with a CQI; and
receiving a confirmation message based on other precoding vectors and wireless transmit/receive pairings and on condition that the confirmation message is negative, further receiving another precoding vector,
wherein the unitary codebook comprises unitary matrices and each matrix includes potential precoding vectors.

30. The method as in claim 29, wherein the same another precoding vector is used for all resource block groups.

31. The method as in claim 29, wherein the another precoding vector is received over a receiving a reference signal (RS) having at least one precoded precoding vector.

32. A wireless transmit/receive unit (WTRU) using precoding matrix signaling, comprising:
a transmitter transmitting an estimate of channel state information;
a receiver receiving a selected precoding matrix based on at least one channel state information estimate; and
the receiver receiving a number of paired wireless transmit/receive units (WTRUs),
wherein precoding matrices are distinct and knowledge of a WTRU's own precoding vector implies knowledge of any interfering precoding vectors.
